(19) United States
(12) Patent Application Publication
(10) Pub. No.: US 2007/0266112 A1
(43) Pub. Date: Nov. 15, 2007

(54) Technique to incorporate human interaction during document routing

(75) Inventor: Gopinath Duddi, Hayward, CA (US)

Correspondence Address: HOVEY WILLIAMS LLP, 2405 GRAND BLVD., SUITE 400, KANSAS CITY, MO, 64108, US

(73) Assignee: International Business Machines Corporation, Armonk, NY (US)

(21) Appl. No.: 11/432,652

(22) Filed: May 11, 2006

(51) Int. Cl. G06F 15/16

(52) U.S. Cl. 709/217

(57) ABSTRACT

A computer program product enables selective human interaction in an automated document routing process. The computer program enables users associated with one or more nodes of the process to selectively flag a document for human intervention at one or more other process nodes. When the document is moved to a node that has been flagged for human intervention, the program generates a verification code from a hardware address associated with the node, an identifier associated with the document, and a time, presents the code to a user associated with the node, and prompts the user to submit the verification code. The program only moves the document out of the node when the user submits an input matching the verification code.

### BACKGROUND OF THE INVENTION

1. Field of the Invention

The present invention relates to the field of automated document routing. More particularly, the present invention relates to an automated document routing system that enables users to require human approval of a document at a specified node of the document route.

2. Description of Prior Art

Automated document routing assists in the processing of documents by automatically transferring electronic documents from one node to the next of a pre-determined process. A process is a series of steps, or nodes, through which a document is routed. Processes may be defined by an administrator, business analyst, or other authorized person. Such systems are commonly used in companies where a large amount of documents are processed through various nodes.

An exemplary automated workflow process with automated document routing is illustrated in FIG. 1, wherein an automobile insurance document workflow is illustrated. In the process illustrated in FIG. 1, a computer system receives an insurance claim folder (document container or group of documents) containing a claim form, a police report, and a repair estimate of a damaged automobile, and processes the claim folder to determine whether to approve or reject the claim. The system requires all three documents to be present in the folder before reviewing the claim.

First, a claim folder containing a claim form is submitted for processing at the “Submit Claim” node. The claim folder is forwarded to the “Wait for Report and Estimate” node, where it remains until the proper documents have been added to the folder. This type of a node is referred to as a collection node.

When the required documents are added to the claim folder, the claim folder automatically advances to the first decision point in the claim process. At the first decision point, one or more documents of the folder are evaluated to determine whether the claim is for an amount greater than $500. A person may evaluate the folder at the first decision point to determine the claim amount, or a computer may evaluate the folder by, for example, reading one or more attributes of a folder document.

If the claim amount is greater than $500, the claim folder automatically advances to a set of parallel routes for handling large claims. Otherwise, the claim folder automatically advances to a node for handling the claim folder with a claim amount less than or equal to $500, wherein the node for handling small claim folders includes reviewing the small claim and advancing to a second decision point.

There are two parallel routes to handle the folder if the claim amount is larger than $500. A split node indicates the beginning of the parallel routes. One parallel route first reviews the claimant's credit and then checks the claimant's fraud history by, for example, launching an external Line-Of-Business application (such as a CICS or IMS application). The other parallel route reviews the large claim. A join node waits for the completion of the two parallel routes before advancing to the second decision point.

The second decision point determines whether to accept or reject the claim by, for example, evaluating a workflow variable. If the variable is equal to “accept,” a “pay claim” subprocess is started, and a thank-you letter is generated and sent to the claimant. If the variable is equal to “reject,” a rejection letter is generated and sent to the claimant. At this point the claim folder has reached the end of the claim process.

Unfortunately, automated routing systems such as that illustrated in FIG. 1 suffer from various problems and limitations. An administrator, business analyst or other person with the proper authority can define processes and how documents are routed in the processes, and determine which documents are routed through which processes. However, the person who defines a process may not be involved in the day-to-day use of the process and therefore is not aware of particular issues that arise with certain documents that require attention not originally prescribed by the process. Furthermore, even if the person who defines a process were aware of all such issues, it would be impractical or impossible to design a process to accommodate all of the issues associated with each and every document.

Accordingly, there is a need for an improved automated document routing system that does not suffer from the problems and limitations of the prior art.

### SUMMARY OF THE INVENTION

The present invention overcomes the above-described problems and limitations in the art and provides an improved automated routing system for workflow processes that enables users associated with process nodes to selectively modify how a document is routed through the process to address issues specific to the document. Particularly, the present invention provides an automated document routing system that enables users to require human approval of a document at a specified node of the document route.

A first embodiment of the invention is a computer program product comprising a computer usable medium including computer usable program code for routing a document through a process including a first node and a second node. The computer program product comprises computer usable program code for automatically moving a document from the first node to the second node, for enabling a first user associated with the first node to selectively flag the document, for determining whether the document has been flagged and requiring an acknowledgment from a second user if the document has been flagged, and for determining whether the second user submitted the acknowledgement and moving the document out of the second node only if the second user submits the acknowledgement.

A second embodiment of the invention involves a computer program product comprising computer usable program code for routing a document through a process including at least a first node, a second node, and a third node. The computer program product of the second embodiment comprises computer usable program code for automatically moving a document from the first node to the second node, and from the second node to the third node, and for enabling a first user associated with the first node to selectively flag one of the second and third nodes as an intervention node for a particular document.

The computer program product of the second embodiment further comprises computer usable program code for presenting a verification code at the intervention node when the document is at the intervention node and prompting a second user associated with the intervention node to submit the verification code, wherein the verification code is derived from a unique hardware address of the intervention node, a unique identifier of the document, and a timestamp generated by a computing device. Computer usable program code also receives an input from the second user and determining whether the input corresponds to the verification code, and moves the document from the intervention node to a subsequent process node if the input received from the second user corresponds to the verification code, and prompting the second user to resubmit the verification code if the input received from the user does not correspond to verification code.

In a third embodiment, the computer program product comprises computer usable program code for enabling a user to define a process, wherein the process includes a plurality of nodes, a document route through the nodes, and a condition associated with each node, and wherein information pertaining to each node is stored in a database table; computer usable program code for automatically moving a document along the document route by moving the document into and out of each node of the route if the condition associated with the node is satisfied; and computer usable program code for enabling a first user associated with a first one of the plurality of nodes to selectively flag a second one of the plurality of nodes as an intervention node for a particular document, wherein a database table corresponding to the intervention node is modified to include the flag and to identify the document.

The computer program product further comprises computer usable program code for presenting a verification code at the intervention node when the document is at the intervention node and prompting a second user associated with the second node to submit the verification code, wherein the verification code is derived from a unique hardware address of the intervention node, a unique identifier of the document, and a timestamp generated by a computing device; computer usable program code for receiving an input from the second user and determining whether the input corresponds to the verification code; and computer usable program code for moving the document from the intervention node to a subsequent process node if the input received from the second user corresponds to the verification code, and prompting the second user to resubmit the verification code if the input received from the user does not correspond to verification code.

These and other important aspects of the present invention are described more fully in the detailed description below.

### BRIEF DESCRIPTION OF THE DRAWINGS

An embodiment of the present invention is described in detail below with reference to the attached drawing figures, wherein:

FIG. 1 is a flow diagram of a prior art automated workflow process including an automated document routing system;

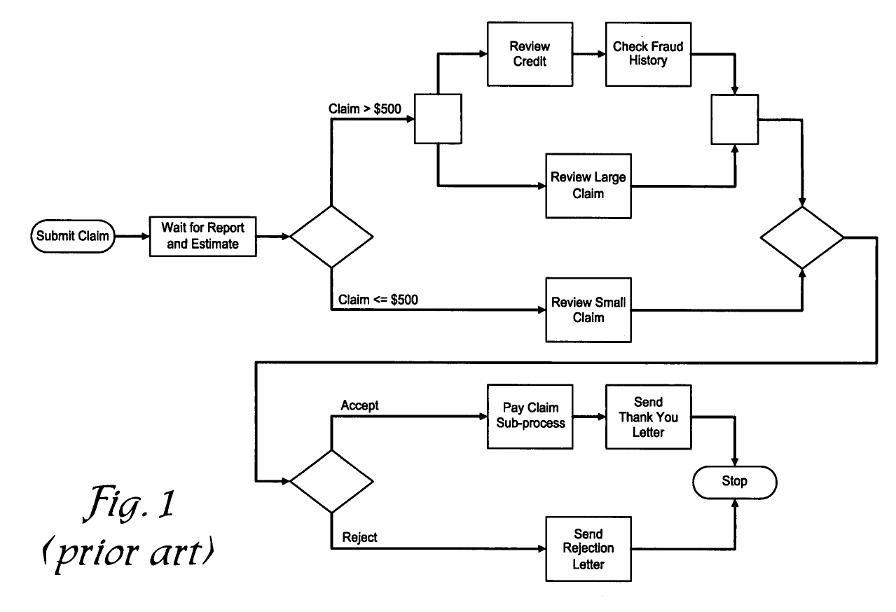

FIG. 2 is a schematic diagram of an exemplary system for implementing a computer program in accordance with a preferred embodiment of the present invention; and

FIG. 3 is a flowchart of certain steps executed by the computer program for routing a document through an automated workflow process, wherein the program enables a user to request human intervention at one or more nodes of the workflow process.

### DETAILED DESCRIPTION OF A PREFERRED EMBODIMENT

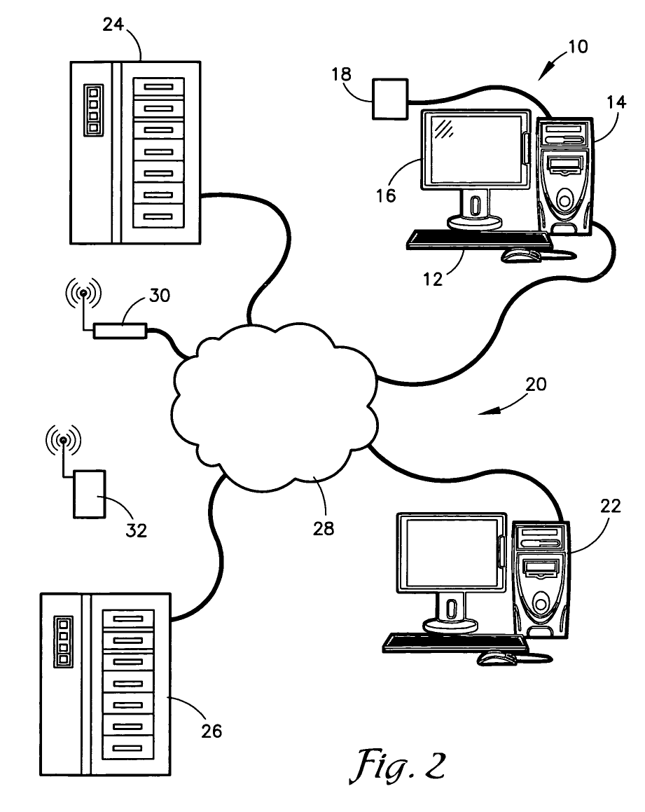

The present invention relates to a method and computer program for automated document routing that enables users associated with process nodes to selectively modify how a document is routed through the process to address issues specific to the document. More particularly, the present invention enables a user to require human interaction at one or more process nodes. The method of the present invention is especially well-suited for implementation on a computer or computer network, such as the computer 10 illustrated in FIG. 2 that includes a keyboard 12, a processor console 14, a display 16, and one or more peripheral devices 18, such as a scanner or printer. The computer 10 may be a part of a computer network, such as the computer network 20 that includes one or more client computers 10,22 and one or more server computers 24,26 and interconnected via a communications system 28. The present invention may also be implemented, in whole or in part, on a wireless communications system including, for example, a network-based wireless transmitter 30 and one or more wireless receiving devices, such as a hand-held computing device 32 with wireless communication capabilities. The present invention will thus be generally described herein as a computer program. It will be appreciated, however, that the principles of the present invention are useful independently of a particular implementation, and that one or more of the steps described herein may be implemented without the assistance of a computing device.

The present invention can be implemented in hardware, software, firmware, or a combination thereof. In a preferred embodiment, however, the invention is implemented with a computer program. The computer program and equipment described herein are merely examples of a program and equipment that may be used to implement the present invention and may be replaced with other software and computer equipment without departing from the scope of the present invention.

The computer program of the present invention is stored in or on a computer-readable medium residing on or accessible by a host computer for instructing the host computer to implement the method of the present invention as described herein. The host computer may be a network server computer, such as server computer 24, or a network client computer, such as computer 10. The computer program preferably comprises an ordered listing of executable instructions for implementing logical functions in the host computer and other computing devices in communication with or accessible by the host computer. The computer program can be embodied in any computer-readable medium for use by or in connection with an instruction execution system, apparatus, or device, such as a computer-based system, processor-containing system, or other system that can fetch the instructions from the instruction execution system, apparatus, or device, and execute the instructions.

The ordered listing of executable instructions comprising the computer program of the present invention will hereinafter be referred to simply as “the program” or “the computer program.” It will be understood by those skilled in the art that the program may comprise a single list of executable instructions or two or more separate lists, and may be stored on a single computer-readable medium or multiple distinct media. The program will also be described as comprising various segments of computer usable program code, which may include one or more lists, or portions of lists, of executable instructions. Program code segments may include overlapping lists of executable instructions—that is, a first code segment may include instruction lists A and B, and a second code segment may include instruction lists B and C.

In the context of this document, a “computer-readable medium” can be any means that can contain, store, communicate, propagate or transport the program for use by or in connection with the instruction execution system, apparatus, or device. The computer-readable medium can be, for example, but is not limited to, an electronic, magnetic, optical, electro-magnetic, infrared, or semi-conductor system, apparatus, device, or propagation medium. More specific, although not inclusive, examples of the computer-readable medium would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM). The computer-readable medium could even be paper or another suitable medium upon which the program is printed, as the program can be electronically captured, via for instance, optical scanning of the paper or other medium, then compiled, interpreted, or otherwise processed in a suitable manner, if necessary, and then stored in a computer memory. As used in this document, a “computer program product” can be, but is not limited to, the combination of a computer program and a computer-readable medium associated with the program.

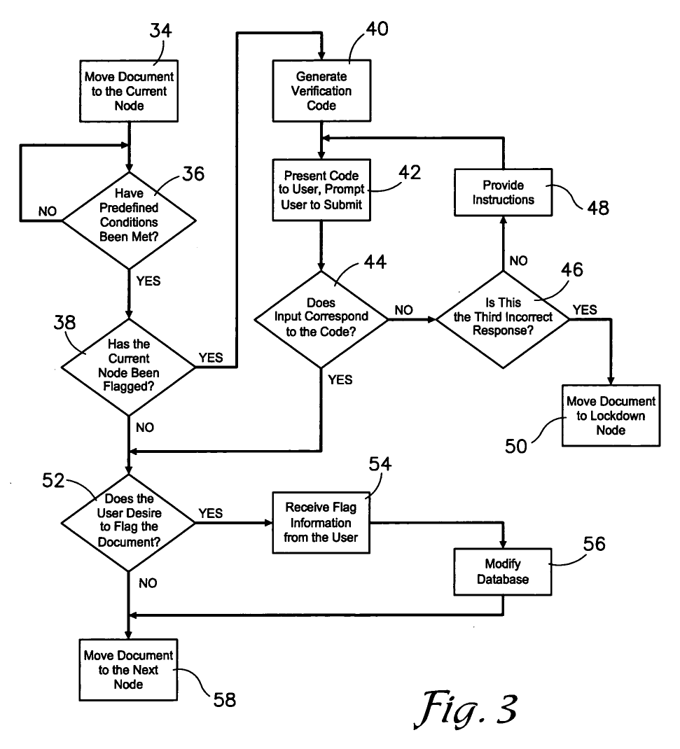

A process, such as a process similar to that illustrated in FIG. 3, is defined by a user, typically an administrator or business analyst. The program stores information defining the process in a database, wherein a plurality of database tables each relate to a process node.

The process comprises a plurality of nodes, one or more conditions associated with each node, and one or more relationships between nodes. A node is a step or station within the process and may correspond, for example, to an action, event, person, device, virtual location, physical location, or a combination thereof. In the embodiment of the invention described herein, a node is generally a computing device associated with a computer network, wherein documents or document folders are moved from one computing device to another via network communication mediums according to network communication protocols. Examples of such computing devices include the network client computers 10,22, the network server computers 24,26, and the wireless computing device 32, all illustrated in FIG. 2, as well as other computing devices operable to communicate with a computer network such as printers, copiers, data storage devices, and facsimile machines.

A condition or conditions associated with a node relate to attributes, events, or actions that are measured or observed while a document is at the node and may be prerequisite to the document moving to another node. Conditions may include, for example, the arrival of one or more external documents to be added to a folder; the approval of a document from a user associated with a node; the arrival of data from an external source to be added to a document; the availability of a subsequent node, such as a printer; the arrival of a document from each of two parallel branches of a process; the acceptance of a document by a computer or a printer; and the completion of a subprocess.

Relationships between nodes define how documents are routed from node to node through the process. A relationship may involve only two nodes, wherein a document is routed from a first node to a second node or vice-versa when certain conditions are satisfied, or may involve three or more nodes. Examples of relationships involving three or more nodes include branching nodes, joining nodes and decision nodes. A document is moved to a branching node from a single prior node, and is then moved to two or more subsequent branch nodes simultaneously. A join node is essentially the opposite of a branch node, wherein a document is moved to a single node from two or more prior nodes. Decision nodes are another example of relationships involving three or more nodes, wherein a document is moved from a first node to a second node only if a certain condition is true, and is moved to a third node from the first node if the condition is not true. Decision nodes can be related to any number of subsequent nodes.

Once the process has been defined, documents are submitted for processing. Depending on the process, document submission may be manual, wherein a user places the document in a start node, or automated, wherein an external process places the document in the start node. With a document in the start node, the program begins the process of routing the document through a workflow defined by the process. The flowchart illustrated in FIG. 3 represents a series of steps the program of the present invention performs each time a document is moved to a node of the process, thereby routing the document from one node to a next. As used in the flowchart, the “current node” is a node the document has recently been moved to, and the “next node” is a node the document will be moved to after the program has performed the steps depicted in the flowchart.

First, the program moves a document to the current node, as depicted in block 34. This is typically an automated step that may involve, for example, retrieving or requesting a document that conforms to the portable document format (PDF) from a first network client computer or network drive and communicating the document to a second network client computer or network drive. If the current node is a start node, this step may require a user to move the document to the current node instead of the program.

The program then verifies that one or more conditions associated with the node have been satisfied, as depicted in block 36. If not, the program waits until the one or more conditions have been satisfied. The program determines the conditions by reading the conditions from a database table associated with the current node wherein, for example, each condition is an attribute of the table.

When the one or more conditions have been satisfied, the program determines whether the node has been flagged for human intervention, as depicted in block 38. This may be done, for example, by reading an attribute from the database table corresponding to the node to determine whether a human interaction flag has been asserted in relation to the document. The human interaction flag may be asserted by a user associated with another process node, by an administrator or analyst overseeing the process, or by another person associated with the process.

If the node has been flagged for human intervention, the program generates a verification code, as depicted in block 40. The verification code is preferably an alpha-numeric text string derived from values or identifiers associated with the node, values or identifiers associated with the document, and a time. More specifically, the verification code may be derived from a network media access control (MAC) address of the node, a work package ID of the document, and a timestamp generated by a computing device, such as a server computer implementing the program. The verification code may be derived from these values or identifiers by combining at least a portion of each, by using at least a portion of each to modify or adjust data, or a combination of these techniques.

The program presents the verification code to a user associated with the current node and prompts the user to submit the verification code, as depicted in block 42. The program communicates the verification code to the current node, wherein a computing device associated with the current node presents the verification code to the user via, for example, a graphical user interface. The user communicates the verification code back to the server to confirm that he or she has reviewed the document and permits further processing of the document.

An exemplary scenario illustrating these events involves a workstation that is a network client corresponding to the current process node. The program communicates the document and the verification code to the workstation, wherein the workstation displays both the document and the code on a monitor so that the user can view them. The workstation also prompts the user to submit the verification code via a user interface element to authorize further processing of the document. Once the user has reviewed the document and decided to permit further processing of the document, he or she types the verification code into the user interface element and submits the verification code by, for example, selecting a “submit” button.

In a second exemplary scenario, a wireless hand-held computing device, such as an organizer, a cell phone, or a combination thereof, is associated with the current node. The program communicates the document and the verification code to the hand-held computing device, wherein the device displays both the document and the code so that the user can view them. The hand-held device also prompts the user to submit the verification code via a user interface element to authorize further processing of the document. Once the user has reviewed the document and decided to permit further processing of the document, he or she enters the code via the user interface element and submits the code.

When the user submits the verification code, the program determines whether the information submitted by the user corresponds to the verification code, as depicted in block 44. If not, the program determines whether this is the third consecutive time it has received data from the user that does not correspond to the original verification code, as depicted in block 46. If not, the program presents the code to the user once again with instructions to re-submit the code exactly as it is presented to the user, as depicted in block 48. If the user submits three consecutive incorrect values, the program notifies a predetermined, authorized person, such as an administrator, and sends the document to a lockdown node, as depicted in block 50. Only the authorized person may remove the document from the lockdown node.

It will be appreciated that the program may move the document to the lockdown node after the user submits one, two, four, five, six, or any other number of consecutive incorrect values, and is not limited to three occurrences as shown and described. Furthermore, any of a variety of responses may be implemented for the situation in which the user submits information that does not correspond to the verification code. For example, the program may communicate an alert to an administrator after two consecutive incorrect submissions, and then move the document to the lockdown node if the user submits two more consecutive incorrect values.

Once the user correctly submits the verification code, or if the document has not been flagged for human intervention, the program determines whether the user associated with the current node desires to flag the document for human interaction at another node, as depicted in block 52. The program may do this by, for example, by presenting a “flag” icon in a user interface associated with the current node and listening for selection of the icon, actively prompting the user to provide an indication via a pop-up window, or both.

If the user associated with the current node desires to flag the document, the program receives information from the user indicating which node or nodes should be flagged for human intervention, as depicted in block 54. This may be done, for example, by providing a list of process nodes via a graphical user interface and prompting the user to select one or more nodes (or no nodes) for human interaction, and submitting the response. The program may also supply a list of types of human intervention to request, such as review and approve entire document and review and approve a specified section of the document. In the latter scenario, the program may further enable the user to selectively identify a particular type of human intervention to request for each of a plurality of nodes, wherein the intervention may be different for each node. Furthermore, the program may enable the user to submit specific intervention instructions, such as by providing a text field in which the user may type the instructions.

If the user submits one or more nodes to be flagged, the program modifies a database table corresponding to each flagged node, as depicted in block 56. Each table is modified to reflect the information submitted by the user including an indicator that the node has been selected as an intervention node, the document associated with flag, and any intervention instructions or types submitted by the user. This may involve, for example, setting a human intervention attribute value to “true” and providing a document identifier, such as a work package ID or a title and author, corresponding to the flagged node, to associate the flag with the document. Thus, flagging “the document” may involve modifying a database structure instead of the document itself, may involve

When the program has received the human intervention request from the user associated with the current node, or if the user did not submit a human intervention request, the program moves the document to the next node, as depicted in block 58. If the next node is a stop node, the program does not repeat the steps illustrated in FIG. 3, but may, for example, communicate a notice of complete process to a designated person, such as an administrator.

While an embodiment of the invention has been described in relation to a process of routing a document through a process, the invention may also apply to multiple documents bundled together as a folder. If a folder is used, the program reviews the entire folder at each node to determine if any of the documents contained in the folder have been flagged for human intervention, as explained above in relation to a single document. The step of presenting the verification code to the user and prompting the user to submit the code is substantially the same for a folder as for a document, except that where a folder contains two or more flagged documents, the program presents separate verification codes for each document. The step of enabling the user to assert a human intervention flag is also substantially the same for a folder as for a document, except that where a folder contains two or more documents the program enables the user to selectively flag each document independently of the other documents, and submit separate intervention instructions for each document.

Having thus described a preferred embodiment of the invention, what is claimed as new and desired to be protected by Letters Patent includes the following:

1. A computer program product comprising a computer usable medium including computer usable program code for routing a document through a process including a first node and a second node, said computer program product comprising:
computer usable program code for moving a document from the first node to the second node;
computer usable program code for enabling a first user associated with the first node to selectively flag the document;
computer usable program code for determining whether the document has been flagged and allowing an acknowledgment from a second user if the document has been flagged; and
computer usable program code for determining whether the second user submitted the acknowledgement, and moving the document out of the second node only if the second user submits the acknowledgement.

2. The computer program product as set forth in claim 1, further comprising computer usable program code for creating the acknowledgement and presenting the acknowledgement to the second user.

3. The computer program product as set forth in claim 1, wherein the acknowledgement is an alpha-numeric verification code derived form a network address, a document identifier, and a time.

4. The computer program product as set forth in claim 3, wherein the network address is unique to the second node, the document identifier is unique to the document, and the time is the time at which the acknowledgment is created.

5. The computer program product as set forth in claim 4, wherein the network address is a media access control address of the second node, the document identifier is a work package ID of the document, and the time is a timestamp associated with the document.

6. The computer program product as set forth in claim 1, wherein the first node and the second node are computing devices associated with a computer network.

7. The computer program product as set forth in claim 1, wherein the process includes a third node.

8. The computer program product as set forth in claim 7, further comprising computer usable program code for enabling the first user to selectively associate the flag with either of the second and third nodes.

9. The computer program product as set forth in claim 8, further comprising computer usable program code for determining which node the flag is associated with, requiring an acknowledgement from the second user only if the flag is associated with the second node, and requiring an acknowledgement from a third user only if the flag is associated with the third node.

10. The computer program product as set forth in claim 9, wherein the second user is associated with the second node and the third user is associated with the third node.

11. The computer program product as set forth in claim 1, wherein the document is a first document that is part of a folder associated with one or more other documents, and wherein the computer program product further comprises computer usable program code for automatically moving the one or more other documents associated with the folder from the first node to the second node, and out of the second node, concurrently with the first document.

12. The computer program product as set forth in claim 1, further comprising computer usable code for enabling the first user to selectively specify a requested action and for presenting the requested action to the second user.

13. The computer program product as set forth in claim 1, further comprising computer usable program code for automatically flagging the document if a predetermined condition is true.

14. The computer program product as set forth in claim 1, wherein the process is defined at least in part by one or more database tables containing information relating to the process nodes.

15. The computer program product as set forth in claim 14, further comprising computer usable program code for modifying a portion of the one or more database tables to indicate that the document has been flagged, and for determining whether the document has been flagged by reading the one or more database tables.

16. A computer program product comprising a computer usable medium including computer usable program code for routing a document through a process including at least a first node, a second node, and a third node, said computer program product comprising:
computer usable program code for automatically moving a document from the first node to the second node, and from the second node to the third node;
computer usable program code for enabling a first user associated with the first node to selectively flag one of the second and third nodes as an intervention node for a particular document;
computer usable program code for presenting a verification code at the intervention node when the document is at the intervention node and prompting a second user associated with the intervention node to submit the verification code, wherein the verification code is derived from a unique hardware address of the intervention node, a unique identifier of the document, and a timestamp generated by a computing device;
computer usable program code for receiving an input from the second user and determining whether the input corresponds to the verification code; and
computer usable program code for moving the document from the intervention node to a subsequent process node if the input received from the second user corresponds to the verification code, and prompting the second user to resubmit the verification code if the input received from the user does not correspond to verification code.

17. The computer program product as set forth in claim 16, wherein the process further comprises a lockdown node, wherein the program product further comprises computer usable program code for determining a number of consecutive times the second user has submitted an input that does not correspond to the verification code, and for moving the document out of the verification node and into the lockdown node if the number of consecutive times exceeds a predetermined limit.

18. The computer program product as set forth in claim 17, further comprising computer usable program code for alerting an administrator when the document is in the lockdown node, receiving an authorization from the administrator, and moving the document out of the lockdown node upon receipt of the authorization.

19. The computer program product as set forth in claim 17, further comprising computer usable program code for automatically flagging the document if a predetermined condition is satisfied.

20. A computer program product comprising a computer usable medium including computer usable program code for automated document routing, said computer program product comprising:
computer usable program code for enabling a user to define a process, wherein the process includes a plurality of nodes, a document route through the nodes, and a condition associated with each node, and wherein information pertaining to each node is stored in a database table;
computer usable program code for automatically moving a document along the document route by moving the document into and out of each node of the route if the condition associated with the node is satisfied;
computer usable program code for enabling a first user associated with a first one of the plurality of nodes to selectively flag a second one of the plurality of nodes as an intervention node for a particular document, wherein a database table corresponding to the intervention node is modified to include the flag and to identify the document;
computer usable program code for presenting a verification code at the intervention node when the document is at the intervention node and prompting a second user associated with the second node to submit the verification code, wherein the verification code is derived from a unique hardware address of the intervention node, a unique identifier of the document, and a timestamp generated by a computing device;
computer usable program code for receiving an input from the second user and determining whether the input corresponds to the verification code; and
computer usable program code for moving the document from the intervention node to a subsequent process node if the input received from the second user corresponds to the verification code, and prompting the second user to resubmit the verification code if the input received from the user does not correspond to verification code.
